(19) United States
(12) Patent Application Publication
(10) Pub. No.: US 2005/0138414 A1
(43) Pub. Date: Jun. 23, 2005

(54) Methods and apparatus to support the storage of boot options and other integrity information on a portable token for use in a pre-operating system environment

(76) Inventors: Vincent J. Zimmer, Federal Way, WA (US); Michael A. Rothman, Gig Harbor, WA (US)

Correspondence Address: GROSSMAN & FLIGHT LLC, Suite 4220, 20 North Wacker Drive, Chicago, IL, 60606-6357, US

(21) Appl. No.: 10/737,954

(22) Filed: Dec. 17, 2003

(51) Int. Cl. H04L 9/00

(52) U.S. Cl. 713/201

(57) ABSTRACT

Methods and apparatus to support the storage of boot options and other integrity information on a portable token for use in a pre-operating system environment are disclosed. In one example, a disclosed method may include receiving data at the computer system from a token and selectively locating and receiving an OS image at the computer system from a computer readable medium based on the data, wherein the computer readable medium is different from the token.

### TECHNICAL FIELD

The present disclosure is directed generally to computer systems and, more particularly, to methods and apparatus to support the storage of boot options and other integrity information on a portable token for use in a pre-operating system (pre-boot) environment.

### BACKGROUND

Computing systems include hardware, such as a processor, on which software or firmware is executed. When a processor is powered-up or receives a reset signal, the processor executes a boot sequence during which numerous instructions in firmware are executed in a pre-boot execution environment (PXE), which is an environment in which no operating system (OS) has been loaded.

As computing systems have evolved, the PXE has progressed from a crude interface having limited services to a standards-based interface in which firmware components are modular. One example of such a firmware arrangement is the extensible firmware interface (EFI), which provides a rich, heterogeneous set of services that are callable by various system entities to request execution, to invoke services, etc. For example, the EFI includes a set of core services that are made available through a system table that publishes the addresses at which various services reside so that the services may be called.

Most modern firmware systems, such as EFI, leave variable stores and file systems unprotected, thereby leaving modern firmware systems open to security attacks from humans, viruses, and the like. For example, the EFI system typically stores boot options and boot object authorization (BOA) as clear-text that is human readable and vulnerable to modification, thereby resulting in a system having less than optimal security.

At the same time, there is a desire by information technology (IT) groups around the globe to have the capability to issue to each user a portable personalized identification device that can be used to access securely a computing device, as well as to access one or more networks.

### BRIEF DESCRIPTION OF THE DRAWINGS

FIG. 1 is a block diagram of an example platform-level architecture of a network security system.

FIG. 2 is a block diagram of an example processor system.

FIG. 3 is a flow diagram of an example pre-boot process that may be carried out by the processor system of FIG. 2.

FIG. 4 is a flow diagram of an example token boot process that may be carried out by the processor system of FIG. 2.

FIG. 5 is a flow diagram of an example obtain data process that may be carried out by the processor system of FIG. 2.

### DETAILED DESCRIPTION

The following describes example methods, apparatus, and articles of manufacture that support the storage of boot options and other integrity information on a portable token for use in a pre-operating system environment or PXE. While the following disclosure describes systems implemented using software or firmware executed by hardware, those having ordinary skill in the art will readily recognize that the disclosed systems could be implemented exclusively in hardware through the use of one or more custom circuits, such as, for example, application-specific integrated circuits (ASICs), or any other suitable combination of hardware and/or software.

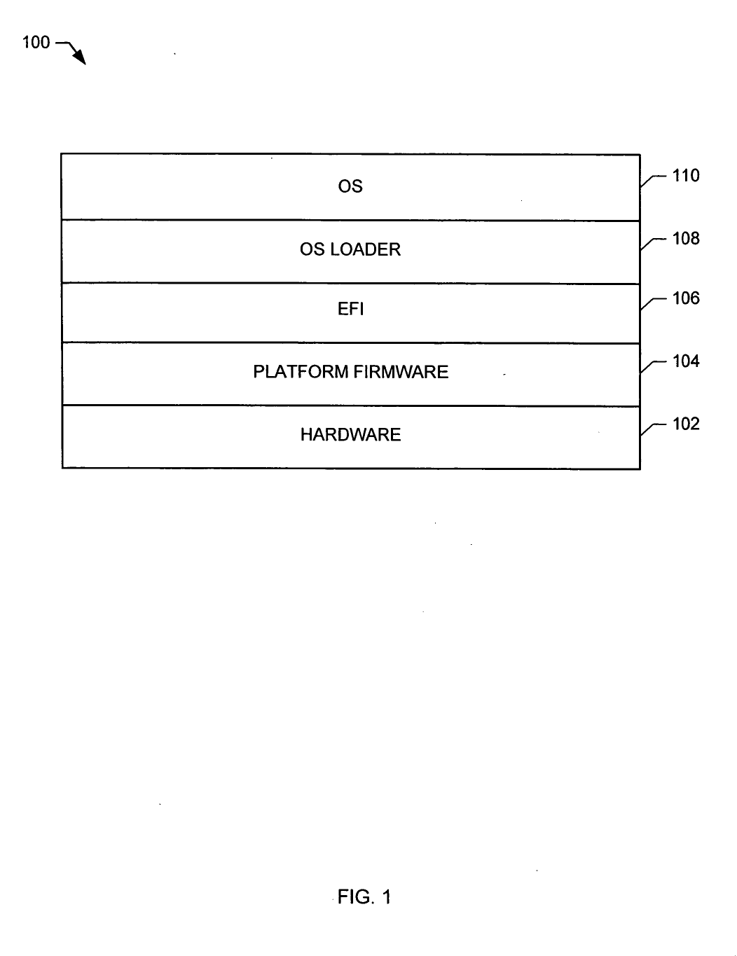

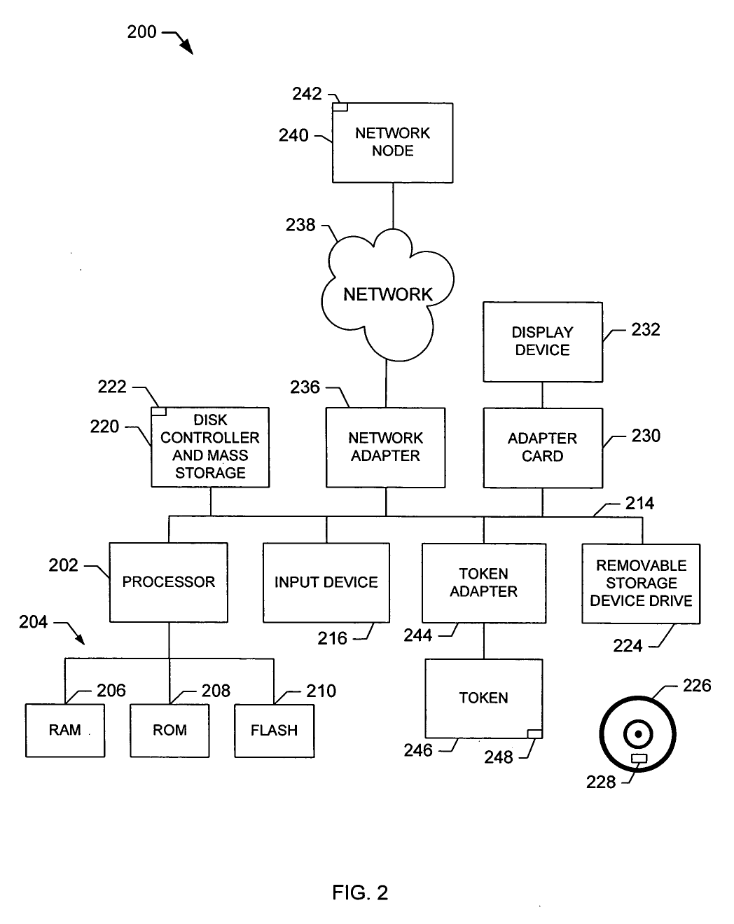

As shown in FIG. 1, an illustrated architecture of a network security system 100 includes hardware 102, a platform firmware (e.g., a basic input/output system (BIOS)) 104, an EFI 106, an OS loader 108, and an OS 110. Persons of ordinary skill in the art will readily recognize that hardware 102 may include any physical aspect of the network system 100 such as a network interface (e.g., the network adapter 236 of FIG. 2), a processor (e.g., the processor 202 of FIG. 2), and a system memory (e.g., the system memory 204 of FIG. 2). Hardware 102 also typically includes interface circuit(s), input device(s), output device(s), and/or mass storage device(s). The hardware 102 will be described below in greater detail in conjunction with FIG. 2.

Upon power up of the network system 100, the hardware 102 is actuated and executes the platform firmware 104. The platform firmware 104 initiates the EFI 106. For example, the EFI 106 may have a boot manager that when initiated by the platform firmware 104 will attempt to load EFI drivers and EFI applications (e.g., the OS loader 108). The OS loader 108 starts the OS 110 and then may terminate the execution of the OS loader 108.

The platform firmware 104 may be implemented as software, firmware, or machine readable instructions to boot up (i.e., start up) the network system 100 in a conventional manner. The platform firmware 104 manages data flow between the OS loader 108 and the hardware 102 of the network system 100 via the EFI 106 in order to run pre-boot applications and to boot the OS 110.

The EFI 106 is used to define an interface between the OS 110 and the platform firmware 104 in order to assist the platform firmware 104 in managing data flow. The EFI 106 includes boot and runtime service calls that are available to the OS 110. Accordingly, the EFI 106 provides a standard environment for booting the OS 110 and running pre-boot applications. Additional information pertinent to the EFI 106 is available at http://developer.intel.com/technology/efi. Alternatively, the platform firmware 104 may communicate directly with the OS 110 in a conventional manner without the EFI 106.

The OS loader 108 enables the network system 100 to load the OS 110. For example, the OS 110 may be a Microsoft Windows® OS, UNIX® OS, Linux OS, etc., each of which may need to be loaded in a different manner. As mentioned previously, after the OS loader 108 completely starts the OS 110 the OS loader 108 may terminate and the OS 110 will communicate with the platform firmware 104 either directly or indirectly through the EFI 106.

FIG. 2 illustrates an example processor system 200 on which the disclosed processes may be executed. The system 200 includes a processor 202 having associated system memory 204, which may be implemented using, for example, random access memory (RAM) 206, read only memory (ROM) 208, and/or flash memory 210. The processor 202 is coupled to an interface, such as a bus 214, to which other components may be coupled. In the illustrated example, the components interfaced to the bus 214 include an input device 216, a mass storage device 220 that may include a locally-loaded OS image 222, and a removable storage device drive 224 that may include associated removable storage media 226, such as magnetic or optical media. The removable storage media 226 may include a removable media-loaded OS image 228 that may be similar to the locally-loaded OS image 222. The example processor system 200 may also include an adapter card 230 operatively coupled to a display device 232 and a network adapter 236 such as, for example, an Ethernet card or any other card that may be wired or wireless.

The example processor system 200 may be implemented using, for example, a server, a conventional desktop personal computer, a notebook computer, a workstation, or any other computing device. The processor 202 may be any type of processing unit, such as a microprocessor from the Intel X-Scale® family of processors, the Intel Internet Exchange Processor® (IXP) family of processors, the Intel Pentium® family of microprocessors, Intel Itanium® family, or any processor available from Intel® or from any other manufacturer.

The memories 206, 208, and 210, which form some or all of the system memory 204, may be any suitable memory devices and may be sized to fit the storage demands of the example processor system 200. The RAM 206 may be implemented using a dynamic random access memory (DRAM), a static random access memory (SRAM), or any other suitable memory device. The flash memory 210 is a low-cost, high-density, high-speed architecture having low power consumption and high reliability. The flash memory 210 is a non-volatile memory that is accessed and erased on a block-by-block basis.

The input device 216 may be implemented using a keyboard, a mouse, a touch screen, a track pad, or any other device that enables a user to provide information to the processor 202. The mass storage device 220 may be, for example, a conventional hard drive or any other magnetic or optical media that is readable by the processor 202. For example, the mass storage device 220 may be a hard drive having storage capacity on the order of hundreds of megabytes to tens or hundreds of gigabytes. The mass storage device 220 may include the locally-loaded OS image 222 or a plurality of locally-loaded OS images. For example, the locally-loaded OS image 222 may be an EFI executable, such as, a Microsoft Windows® OS, a Linux OS, or any suitable OS. The locally-loaded OS image 222 may be similar to the OS 110 of FIG. 1.

The removable storage device drive 224 may be, for example, an optical drive, such as a CD-R drive, a CD-RW drive, a DVD drive, or any other optical drive. It may alternatively be, for example, a magnetic or solid state media drive. The removable storage media 226 is complementary to the removable storage device drive 224, inasmuch as the media 226 is selected to operate with the removable storage device drive 224. For example, if the removable storage device drive 224 is an optical drive, the removable storage media 226 may be a CD-R disk, a CD-RW disk, a DVD disk, or any other suitable optical disk. On the other hand, if the removable storage device drive 224 is a magnetic media device, the removable storage media 226 may be, for example, a diskette or any other suitable magnetic storage media. The removable storage media 226 may include the media-loaded OS image 228. For example, the media-loaded OS image 228 may be a version of Linux, such as MEPIS Linux, that is capable of executing live from a removable storage media 226, such as a CD. Alternatively, the media-loaded OS image 228 could be any of the above-mentioned OSs.

The adapter card 230 may be any standard, commercially available adapter card that is used to interface the processor 202 to the display device 232. The display device 232 may be, for example, a liquid crystal display (LCD) monitor, a cathode ray tube (CRT) monitor, or any other suitable device that acts as an interface between the processor 202 and a user via the adapter card 230. The adapter card 230 is any device used to interface the display device 232 to the bus 214. Such cards are presently commercially available from, for example, Creative Labs and other like vendors.

The network adapter 236 provides network connectivity between the processor 202 and a network 238, which may be a local area network (LAN), a wide area network (WAN), the Internet, public switched telephone network (PSTN), or any other suitable network. The network 238 may include one or more network nodes, such as a network node 240 that may include at least one network-loaded OS image 242.

The network node 240 may be implemented using a remote installation service (RIS) server, a personal computer (PC), a personal digital assistant (PDA), an Internet appliance, a cellular telephone, or any other computing device. In operation, the processor 202 may send a request through the network 238 to the network node 240 for the network-loaded OS image 242. The network node 240 may send a response through the network 238 to the processor 202. The request and the response may be communicated via any protocol, standard or proprietary, such as trivial file transfer protocol (TFTP), user datagram protocol (UDP), dynamic host configuration protocol (DHCP), multicast TFTP (MTFTP), etc. The request may be a request to load or execute the network-loaded OS image 242 on the processor 202. The response may include the entire network-loaded OS image 242 or a portion of the same. Furthermore, the network-loaded OS image 242 may be transmitted over the network 238 using a security method, such as Kerberos, secure socket layer (SSL), transport layer security (TLS), secure shell (SSH), secure remote password (SRP), etc. In an alternative example processor system, the processor 202 may be operatively coupled to the network node 240 without the assistance of the network 238, such as via a serial adapter, a parallel adapter, the network adapter 236 operatively coupled to a cross-over Ethernet cable, etc.

The example processor system 200 also includes a token adapter 244 configured to receive a token 246. The token adapter 244 may be a smartcard (e.g., an ISO7816 compliant smartcard) adapter, a memory stick adapter, a Universal Serial Bus (USB) connector, or any other device capable of accepting the token 246. The token 246 may be implemented using a smartcard (e.g., an ISO7816 compliant smartcard), a read-only CD, or any other device that is capable of being a tamper-proof token. The token 246 may include a Boot Object Authorization (BOA) 248.

The BOA 248 is typically a binary object containing a public key for purposes of corroborating the integrity (i.e., validating) of an OS image (e.g., one or more of the locally-loaded OS image 222, the media-loaded OS image 228, the network-loaded OS image 242, etc.) using any of one or more well known integrity checking algorithms. In one example, the public key may be a 2048-bit RSA key. Additionally, a personal identification number (PIN) and/or a biometric sensor may be employed along with the token 246 for enhanced security.

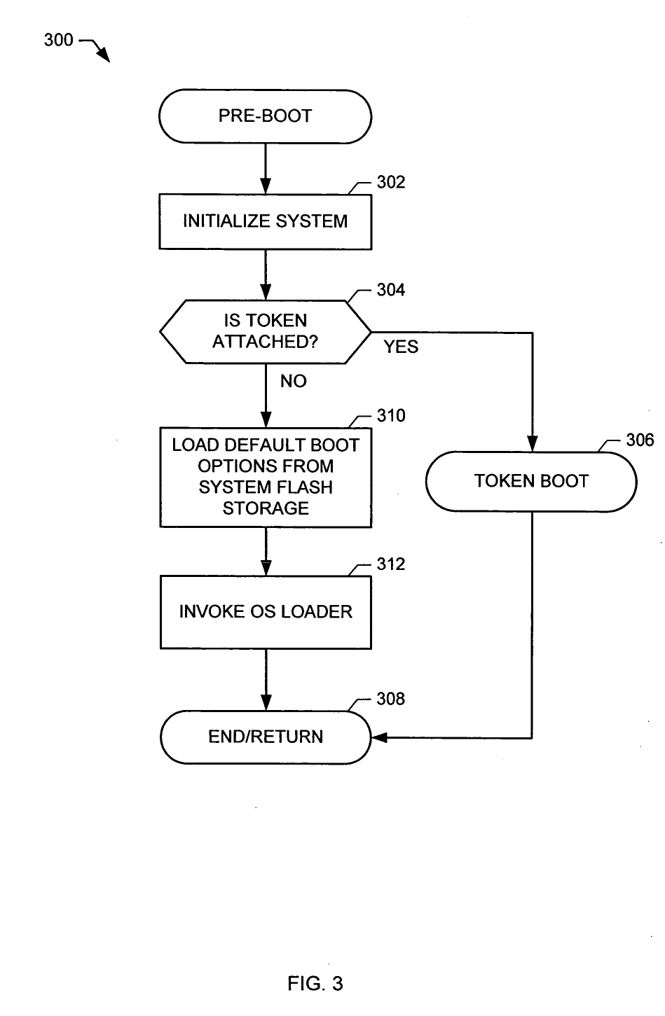

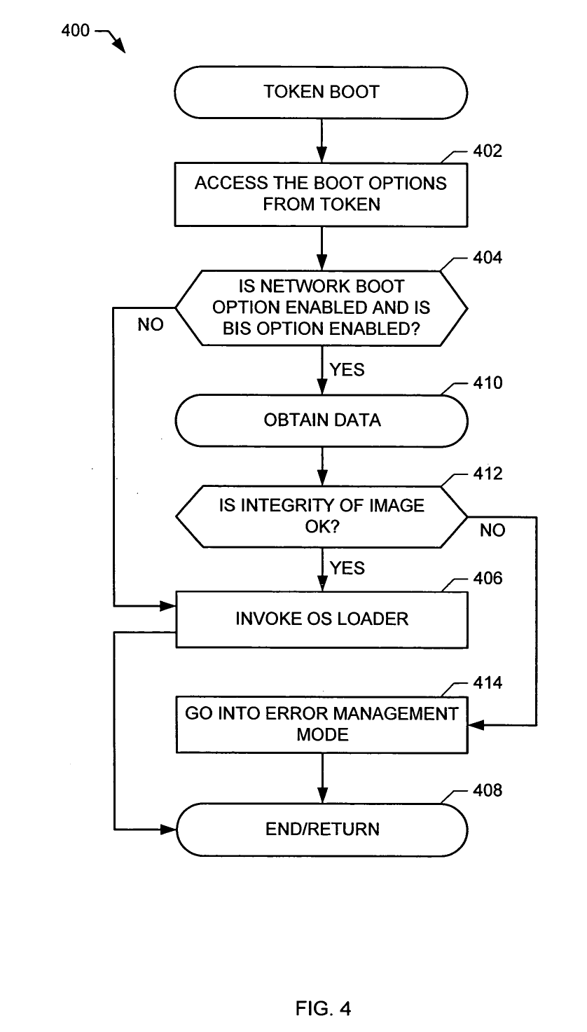

During pre-boot, for example, a user of the example processor system 200 may insert a token (e.g., the token 246) which includes a BOA (e.g., the BOA 248) that results in the selection of an OS image (e.g., the locally-loaded OS image 222, the media-loaded OS image 228, the network-loaded OS image 242, etc.), and the selected OS image is loaded or executed from the mass storage device 220, removable storage device drive 224, the network 238, etc. Further detail pertinent to the selection and loading of an OS image is provided below in conjunction with FIGS. 3 and 4.

A pre-boot process 300, as shown in FIG. 3, may be implemented using one or more software programs or sets of instructions that are stored in one or more memories (e.g., the memories 206, 208, 210) and executed by one or more processors (e.g., the processor 202). However, some or all of the blocks of the pre-boot process 300 may be performed manually and/or by some other device. Additionally, although the pre-boot process 300 is described with reference to the flow diagram illustrated in FIG. 3, persons of ordinary skill in the art will readily appreciate that many other methods of performing the pre-boot process 300 may be used. For example, the order of many of the blocks may be altered, the operation of one or more blocks may be changed, blocks may be combined, and/or blocks may be eliminated. Furthermore, while the processes 300 and 400 are shown as being separate diagrams, those having ordinary skill in the art will readily recognize that the two processes could be combined and represented in a single diagram. The description of the processes of FIGS. 3 and 4 are provided with reference to the components of FIG. 2 for ease of understanding, and accordingly such references are for illustrative purposes and should not be considered to be limiting.

The instructions for the pre-boot process 300 may be stored in a processor boot block that may be located within the flash memory 210. As will be readily appreciated by those having ordinary skill in the art, the boot block is a firmware portion that is executed when a processor (e.g., the processor 202) undergoes a reset. The pre-boot process 300 begins execution by initializing the system (block 302). The initialization of the system (block 302) may include initializing the memory (e.g., the RAM 206, etc), loading a plurality of drivers (e.g., the drivers that enable operation of the token adapter 244), and preparing to boot the system, etc.

After initializing the system (block 302), the pre-boot process 300 determines if the token 246 is attached to the token adapter 244 (block 304). For example, the pre-boot process 300 may send a read request to the token 246 via the token adapter 244. If the token adapter 244 and/or token 246, for example, respond with an error status, the token 246 may be determined to be unattached; otherwise the token 246 may be determined to be attached. If the token 246 is attached (block 304), the pre-boot process 300 invokes the token boot process (block 306). Upon returning from the token boot process 306, the pre-boot process 300 ends or is terminated by the loading of an OS (block 308). The token boot process (block 306) is described in greater detail below in conjunction with FIG. 4.

Conversely, if the token 246 is not attached to the token adapter 244 (block 306), the pre-boot process 300 loads a plurality of default boot options from a system flash storage (block 310). The system flash storage may be implemented as part or all of the flash 210 or as any other suitable flash storage device. An example boot option may be a Boot000X option that stores a network address of a corporate recovery server. In the case of a failure to boot, for example, the pre-boot process 300 could use the network address to contact a corporate recovery server for assistance with booting.

After the pre-boot process 300 loads the default boot options from system flash storage (block 310), the pre-boot process 300 invokes the OS loader 108 of FIG. 1 to load an OS image (e.g. the locally-loaded OS image 222, the media-loaded OS image 228, etc.) (block 312). The invocation of the OS loader 108 may start up the locally-loaded OS image 222, such as Windows, Linux, UNIX, etc. Additionally, there may be a plurality of locally-loaded OS images 222 and/or media-loaded OS images stored on the mass storage device 220 and/or on the removable storage device 224 respectively. The selection of the locally-loaded OS image 222 to invoke by the OS loader 108 may be determined based on a value contained within the default boot options from the system flash storage. After the pre-boot process 300 invokes the OS loader 108 on a loaded OS image (block 312), the pre-boot process 300 ends and/or returns control to any calling routines (block 308).

FIG. 4 illustrates an example token boot process 400, which is one example implementation of the token boot process mentioned in block 306 of FIG. 3. As with the pre-boot process 300, the token boot process 400 may be implemented using one or more software programs or sets of instructions that are stored in one or more memories (e.g., the memories 206, 208, 210) and executed by one or more processors (e.g., the processor 202). Some or all of the blocks of the token boot process 400 may be performed manually and/or by some other device. Additionally, although the token boot process 400 is described with reference to the flow diagram illustrated in FIG. 4, persons of ordinary skill in the art will readily appreciate that many other methods of performing the token boot process 400 may be used. For example, the order of many of the blocks may be altered, the operation of one or more blocks may be changed, blocks may be combined, and/or blocks may be eliminated.

The token boot process 400 begins by accessing a boot option or a plurality of the boot options from the token 246 (block 402). For example, the token 246 may include a boot option that, when enabled, signifies that the example processor system 200 is required to boot from the network-loaded OS image 242 located on the network 238 and when disabled signifies that the example processor system 200 is required to boot from the locally-loaded OS image 222 or the media-loaded OS image 228, which may be on the mass storage device 220 and/or on the removable storage device 224, respectively (i.e., a network boot option).

Alternatively or additionally, a boot integrity services (BIS) option may exist. When enabled the BIS option may signify that an integrity check on the network-loaded OS image 242 must be preformed before activating the network-loaded OS image 242. The typical implementations of the integrity check (i.e., validation) of the network-loaded OS image 242 will be discussed further in conjunction with FIG. 4.

After accessing the boot options from the token 246 (block 402), the token boot process 400 determines if both the network boot option is enabled and the BIS option is enabled (block 404). The boot options may be determined to be enabled, if the value of the boot option is a logical ONE or non-zero and disabled if the value of the boot option is a logical ZERO. If either option is disabled (block 404), the token boot process 400 invokes the OS loader 108 in a significantly similar manner as described for block 312 in FIG. 3 on the network-loaded OS image 242 (block 406). After the token boot process 400 invokes the OS loader 108 on the network-loaded OS image 242 (block 406), the token boot process 400 ends and/or returns control to any calling routines (block 408).

Conversely, if both options are enabled (block 404), the token boot process 400 invokes the obtain data process (block 410). After the token boot process 400 invokes the obtain data process (block 410), the token boot process 400 determines the integrity of the network-loaded OS image 242 (block 412). The integrity check of the network-loaded OS image 242 may be implemented using a digital signature algorithm (DSA) to validate the network-loaded OS image 242. The DSA may load a digital signature generated by the network node 240 that includes BIS-aware management application software and may load the public key from the BOA 248. If the integrity of the network-loaded OS image 242 is intact (block 412), the token boot process 400 invokes the OS loader 108 on the network-loaded OS image 242 (block 406), and then the token boot process 400 ends and/or returns control to any calling routines (block 408).

Conversely, if the integrity of the network-loaded OS image 242 is not intact (block 412), the token boot process 400 will enter an error management mode (block 414). The token boot process 400 ends and/or returns control to any calling routines and may additionally return an error status code (block 308).

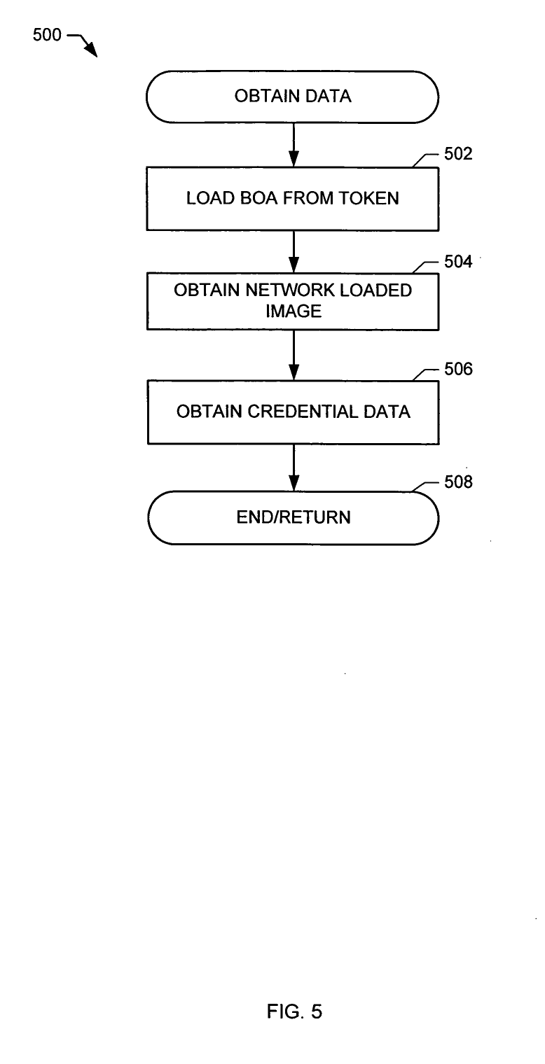

FIG. 5 illustrates an example obtain data process 500, which is one example implementation of the obtain data process mentioned in block 410 of FIG. 4. As with the pre-boot process 300 and the token boot process 400, the obtain data process 500 may be implemented using one or more software programs or sets of instructions that are stored in one or more memories (e.g., the memories 206, 208, 210) and executed by one or more processors (e.g., the processor 202). Some or all of the blocks of the obtain data process 500 may be performed manually and/or by some other device. Additionally, although the obtain data process 500 is described with reference to the flow diagram illustrated in FIG. 5, persons of ordinary skill in the art will readily appreciate that many other methods of performing the obtain data process 500 may be used. For example, the order of many of the blocks may be altered, the operation of one or more blocks may be changed, blocks may be combined, and/or blocks may be eliminated.

The obtain data process 500 begins by loading the BOA 248 from the token 246 (block 502). After loading the BOA 248 from the token 246 (block 502), the obtain data process 500 retrieves the network-loaded OS image 242 from the network 238 (block 504). The network-loaded OS image 242 may be retrieved from the network 238 via the network adapter 236 in a similar manner as described above in conjunction with FIG. 2. The location of the network-loaded OS image 242 on the network 238 may be retrieved from the token 246. Alternatively or additionally, the network-loaded OS image 242 may be stored on a storage area network (SAN) and retrieved via a storage adapter that is operatively coupled to the SAN. The storage adapter may be a fiber optic controller card, or any other device that allows connectivity to the SAN.

After the obtain data process 500 retrieves the network-loaded OS image 242 from the network 238 (block 504), the obtain data process 500 retrieves credential data from the network 238 (block 506). The credentials typically comprise a signed manifest. The signed manifest may have been generated by the network node 240 using a private key. Additionally, the signed manifest may have been encrypted by an encryption program using the private key and thus require decrypting by a decryption program using the public key from the BOA 248.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

1. A method of starting a computer system, the method comprising:
receiving data at the computer system from a token; and
selectively locating and receiving an OS image at the computer system from a computer readable medium based on the data, wherein the computer readable medium is different from the token.

2. A method as defined by claim 1, wherein the data comprises a BIS option.

3. A method as defined by claim 1, wherein the data comprises a network boot option.

4. A method as defined by claim 1, wherein the data comprises a Boot000X option.

5. A method as defined by claim 4, wherein the Boot000X option from the token specifies a location of a corporate recovery server.

6. A method as defined in claim 1, further comprising:
validating of the OS image; and
executing the OS image if the OS image is not corrupted.

7. A method as defined in claim 1, further comprising:
validating of the OS image; and
executing an error handling instruction if the OS image is corrupted.

8. A method as defined by claim 1, wherein the data from the token specifies a location of the OS image.

9. A method as defined by claim 8, wherein the OS image is a locally-loaded OS image.

10. A method as defined by claim 8, wherein the OS image is a network-loaded OS image.

11. A method as defined by claim 8, wherein the OS image is a removable media-loaded OS image.

12. A method as defined by claim 1, wherein the token is a smartcard.

13. A method as defined by claim 1, wherein the data comprises a public key.

14. A method as defined by claim 13, wherein the computer readable medium comprises a signed manifest.

15. A method as defined by claim 14, wherein the computer readable medium comprises a digital signature.

16. A method as defined by claim 15, wherein the public key, the signed manifest, and the digital signature are used to validate the OS image.

17. An article of manufacture comprising a machine-accessible medium for use with a processor of a computing system, the machine-accessible medium having a plurality of machine accessible instructions that, when executed, cause the computing system to:
receive data at the processor from a token; and
selectively locate and receive an OS image at the processor from a computer readable medium based on the data, wherein the computer readable medium is different from the token.

18. An article of manufacture as defined by claim 17, wherein the token comprises a public key.

19. An article of manufacture as defined by claim 18, wherein the computer readable medium comprises a signed manifest.

20. An article of manufacture as defined by claim 19, further comprising the machine-accessible medium having a plurality of machine accessible instructions that, when executed, cause a computing system to validate a digital signature using the public key from the token and the signed manifest from the computer readable medium.

21. An article of manufacture as defined by claim 19, wherein the computer readable medium comprises a private key.

22. An article of manufacture as defined by claim 17, further comprising the machine-accessible medium having a plurality of machine accessible instructions that, when executed, cause the computing system to:
validate the OS image; and
execute the OS image if the OS image is not corrupted.

23. An article of manufacture as defined by claim 17, further comprising the machine-accessible medium having a plurality of machine accessible instructions that, when executed, cause a computing system to:
validate the OS image; and
execute an error handling instruction if the OS image is corrupted.

24. An article of manufacture as defined by claim 17, wherein the data from the token specifies a location of the OS image.

25. A system comprising:
a main memory;
a storage medium; and
a processor coupled to the main memory, wherein the processor is configured to:
receive data at the processor from a token; and
selectively locate and receive an OS image at the processor from the storage medium based on the data, wherein the storage medium is different from the token.

26. A system as defined by claim 25, wherein the processor is further configured to:
validate of the OS image; and
execute the OS image if the OS image is not corrupted.

27. A system as defined by claim 25, wherein the processor is further configured to:
validate of the OS image; and
execute an error handling instruction if the OS image is corrupted.

28. A system as defined by claim 25, wherein the data from the token specifies a location of the OS image.

29. A system as defined by claim 25, further comprising a decryption program that is capable of decrypting a signed manifest.
